(19) United States
(12) Patent Application Publication
(10) Pub. No.: US 2010/0139933 A1
(43) Pub. Date: Jun. 10, 2010

(54) Thermally-Activated Heat Resistant Insulating Apparatus

(76) Inventors: Andrew J. Guenthner, Ridgecrest, CA (US); Michael E. Wright, Ridgecrest, CA (US); Stephen Fallis, Ridgecrest, CA (US)

Correspondence Address: NAVAIRWD;COUNSEL GROUP (CODE K0000D), 1 ADMINISTRATION CIRCLE, STOP 1009, CHINA LAKE, CA, 93555-6100, US

(21) Appl. No.: 12/172,825

(22) Filed: Jul. 14, 2008

Related U.S. Application Data
(62) Division of application No. 11/151,188, filed on May 27, 2005, now abandoned.

(51) Int. Cl. A62C 2/00; B32B 3/06; A62C 5/00

(52) U.S. Cl. 169/48; 169/5

(57) ABSTRACT

A firefighting and protection apparatus being thermally-activated and/or heat resistant when subjected to a temperature above a pre-determined limit thermally set chemical reactions occur within the apparatus which causes the apparatus to expand in volume for multifunctional purposes including acting as an insulator against heat, an absorbent for diminishing contact between fuel and oxygen, and release inert gases and flame retardants for disrupting chemical reactions that sustain a fire.

### STATEMENT REGARDING FEDERALLY SPONSORED RESEARCH OR DEVELOPMENT

The invention described herein may be manufactured and used by or for the government of the United States of America for governmental purposes without the payment of any royalties thereon or therefor.

### FIELD OF THE INVENTION

Embodiments of the present invention relate to a firefighting and protection apparatus, more specifically, a thermally-activated, heat resistant apparatus that when subjected to a temperature above a pre-determined limit thermally set chemical reactions occur within the apparatus which causes the apparatus to expand in volume for multifunctional purposes including acting as an insulator against heat, an absorbent for diminishing contact between fuel and oxygen, and release inert gases and flame retardants for disrupting chemical reactions that sustain a fire.

### BACKGROUND OF THE INVENTION

Jet fuels (such as AVGAS) present a principal problem in aircraft firefighting, and since fires aboard ships and aircraft present a substantially magnified threat to life and property, apparatuses that are especially suited to aid in fighting aircraft fires aboard ship are of high significance to the military and marine/chemical industries. An enveloping fire often causes aircraft fuel tanks to melt or rupture which spills fuel onto the deck, rather than exploding; a combination of fuel absorbing and fire resistance capabilities would provide significant benefits in the vicinity of these types of fuel tanks incidents. Moreover, currently employed explosive suppressant foams on fuel tanks can melt in a fire, forming flammable liquids.

In state-of-the-art materials, compact and lightweight fire suppression systems such as fire extinguishers and sprinklers require activation by humans or electronically powered machines. Other heat-resistant materials that offer flame resistance and good insulating power (such as asbestos) are typically produced in the expanded form, making them far less compact, or have very limited expansion capabilities (such as aromatic polyamides) and thus must be constructed heavier to achieve equivalent performance. In addition, such devices are typically far less mobile and are thus far less adaptable to provide adequate protection, or provide less protection with equivalent mobility and adaptability.

The combination of physical isolation and tight quarters limit the mobility of persons, mobility of equipment, and storage of a large number of flammable, explosive, and toxic substances that makes fire among the most serious hazards encountered in shipboard environments. In the result of an accident, combat, acts of terrorism, or otherwise, the potential loss of life and damage to equipment during a fire necessitates the deployment of significant resources to prevent, contain, and mitigate shipboard fires. These resources are small pieces of equipment including, but not limited to, smoke and heat detectors, chemical fire extinguishers, respirators, and fire blankets. Other resources are large fixed equipment including, but not limited to, fireproof bulkheads and doors, water tanks, sprinkler or foam dispersal systems, and gas generators. Still yet other resources are large mobile equipment including, but not limited fire and ladder trucks, hoses, firefighting suits, and spill clean up kits.

A vast array of equipment exists because successful firefighting requires multiple activities, including transporting persons to safety while protecting them from flames, smoke, and toxic fumes, sequestration of fuels, elimination of a fire's oxygen supply, interruption of the chemical chain reactions involved in burning, prevention of increases in temperature, and clearing potentially hazardous substances from the area. Most of the small equipment used is either operated manually, or relies on an internal or external power source for operation. The former means of operation requires the sustained presence of individuals in a hazardous environment, while the latter requires complex and sometimes fragile electronic circuitry (itself a fire hazard) to continue operating in an extremely destructive environment.

Agents such as firefighting foams or fire blankets incorporating fuel absorbent materials require activation or use by firefighting personnel or electrically-powered systems. Currently available heat resistant materials (yarns, fabrics, insulation) do not possess an adaptive capability that automatically and without intervention improve heat resistance in response to high temperatures. The same is true for articles such as fire blankets made from these fabrics. In those cases, the article derives its performance from fixed properties involving the composition and arrangement of materials.

In some cases, self-activating fire protection systems had been developed that comprises safety; for instance, a valve or separator connected to a water reservoir that is automatically opened or punctured during a fire. These devices require a large reservoir of water to be effective which adds significantly to their weight and volume, and thus limit their use in environments where space and weight savings are crucial. The hardware that constitutes the activation system may also add significant weight and volume to these devices. Similar devices employ super-absorbent materials that can be hydrated either before or during a fire. These devices expand upon hydration, but are not automatically activated during a fire, and, like the previously mentioned device, require access to a water reservoir.

Some fire protection materials involve the endothermic chemical reaction of component materials incorporated into the insulator. These systems are automatically activated during exposure to elevated temperatures; however, they are not constructed to produce a significant expansion in volume of the protective substance, thus they do not provide significant space savings prior to activation. The protection afforded is also of a short-term nature, with more space required to achieve longer-lasting protection.

Some thermally-activated heat-resistant materials, such as polyimide microballoons, can be incorporated into polymer formulations in a dense form, and, upon exposure to a pre-determined elevated temperature, expand by a typical factor of 50 to 100, significantly reducing the overall density of articles made from the formulation. These microballoons, however, require a physical blowing agent such as n-pentane that must be in a liquid state at the temperature and pressures used during the dense balloon formation process and at any subsequent storage or use temperatures prior to activation. In the liquid state, the blowing agents used are not bound to the balloon and will slowly diffuse through the thin microballoon skin, meaning that long-term storage of microballoons in the dense state is impractical. As a result, all state of the art applications of microballoons involve their lifelong use in the pre-expanded form, which offers no space savings prior to activation.

There exists a need in the art for an alternative means for firefighting and protection systems having un-powered autonomous operation. An ideal device would be constructed in such a way that the natural response of the device to an external stimulus or by detectors changes the structure or composition of the device in a controlled manner in order to perform a desired function. Furthermore, the device should not be prone to pre-mature activation. In addition, the device should provide a protective capability without the need for extra space and weight prior to activation.

It is to be understood that the foregoing general description and the following detailed description are exemplary and explanatory only and are not to be viewed as being restrictive of the present invention, as claimed. Further advantages of this invention will be apparent after a review of the following detailed description of the disclosed embodiments, which are illustrated schematically in the accompanying drawings and in the appended claims.

### BRIEF DESCRIPTION OF THE DRAWINGS

FIGS. 1A and B are cross-sectional views illustrating an example of a thermally-activated blanket or mat coated with thermally-activated chemicals, according to embodiments of the present invention.

FIGS. 2A & B are cross-section views illustrating an example of a thermally-activated blanket or mat with at least one heat-resistant layer and a core having thermally-activated chemicals, according to embodiments of the present invention.

FIGS. 3A-E are cross-sectional views illustrating examples a thermally-activated blanket or mat including one core having a wave activation of operation and a thermally-activated blanket or mat having a plurality of cores, according to embodiments of the present invention.

FIGS. 4A-F are perspective views illustrating the use of granules, according to embodiments of the present invention.

FIGS. 5A-J are cross-sectional and perspective views illustrating the process of making a thermally-activated blanket or mat showing initial construction, filling of fibers, compression of fibers, removal of shafts and securing of cover, and activation, according to embodiments of the present invention.

### DETAILED DESCRIPTION OF THE EMBODIMENTS

Embodiments of the present invention generally relate to a thermally-activated fire protection apparatus, constructed for unpowered autonomous operation and performing multiple life-saving and firefighting functions simultaneously.

Embodiments of the present invention relate to a firefighting and fire protection apparatus. Embodiments of the firefighting and fire protection apparatus comprises: at least one compactable support structure having at least one heat-resistant layer and at least one expandable core, at least one heat-resistant layer is coupled to the core, wherein the heat-resistant layer is constructed of heat-resistant materials and/or fibers; at least one effective thermally-activated chemical, wherein the thermally-activated chemical(s) includes at least one of blowing agent(s), flame retardant(s), fuel absorbent(s), and inert gas generating substance(s) and any combination thereof, wherein the thermally-activated chemical(s) is activated when subjected to temperatures above a pre-determined limit, wherein the thermally-activated blowing agents) is formulated for activation when subjected to temperatures above a pre-determined limit, thereafter causes pressure against the support structure(s), wherein the blowing agent(s) causes irreversibly expansion for increasing its volume, wherein the blowing agent(s) creates an effective volume which acts as an effective insulator against heat and having fuel absorbing properties, and wherein the blowing agent(s) having properties for disrupting chemical reactions which create fire and heat; and wherein the apparatus is activated the density of the apparatus is decreased from about 10% to a factor of about 1000 after activation is complete.

Embodiments of the present invention include a firefighting and protection apparatus (referred to as the coating embodiments), comprising: a substrate; and a coating including at least one thermally-activated chemical comprising at least one of blowing agent(s), flame retardant(s), fuel absorbent(s), and inert gas generating substance(s) and any combination thereof, wherein the thermally-activated chemical(s) is activated when subjected to temperatures above a pre-determined limit, wherein the substrate includes a surface capable of being coated with at least one thermally-activated chemical, wherein the thermally-activated blowing agent(s) is formulated for activation when subjected to temperatures above a pre-determined limit, thereafter causes irreversible expansion for increasing its volume, wherein the blowing agent(s) creates an effective volume which acts as an effective insulator against heat and having fuel absorbing properties, and wherein the blowing agent(s) having properties for disrupting chemical reactions which create fire and heat.

In embodiments, when thermally-activated blowing agent(s) and gas generating substance(s) are utilized, they are formulated for activation when subjected to temperatures above a pre-determined limit, thereafter releasing inert gases for causing pressure against the support structure(s). The blowing agent(s) and the gas generating substance(s) causes irreversibly expansion for increasing its volume. The release of inert gases creates an effective volume, which acts as an effective insulator against heat and have fuel absorbing properties. The inert gas generating substance(s) have properties for disrupting chemical reactions which create fire and heat.

In other embodiments, when flame retardant(s) are utilized they include properties that when activated disrupts the chemical reactions that create fires and/or hazardous temperatures. The flame retardant(s) are further combined with a (heat-resistant) polymer comprising at least one of polyvinyl chloride, epoxy, polyurethane, silicone, aromatic polyester, aromatic polyamide, polyimide, polyimidazole, polybenzobisoxazole, polybenzobisthiazole, polyphenylene, phenylene heteratomic polymer (e.g polyphenylene sulfide, polyphenylene oxide), polysulfones, polyvinyl carbazole, polyphosphazine, polysilicate, phenol-formaldehyde resin, bismaleimide resin, phthalonitrile resin, and cyanate ester resin, any halogenated combinations of the above, and any combination thereof for further space and weight savings, heat-resistance, and/or prolonging the life or structural or coating elements in a fire.

When fuel absorbent(s) are utilized having absorbent properties that when activated acts to diminish and/or stop contact between a fuel and surrounding oxygen. In embodiments of the present invention the core comprises at least one enclosed space for housing at least one thermally-activated chemical. In other embodiments, the core includes at least one layer of enclosed spaces dimensioned and configured for housing a plurality of thermally-activated chemicals and expandable support materials for rapid expansion of the apparatus and to increase rigidity of the apparatus for supporting mechanical loads. In embodiments, at least 2% of total spaces are the means for supporting the mechanical loads.

The heat-resistant layer comprises of woven or bound heat-resistant fibers for accommodating the transportation of at least one of gaseous vapors, liquids via capillary action, application of pressure, and any combination thereof. In other embodiments, the heat-resistant layer comprises of woven or bound heat-resistant expandable fibers comprising at least one of glass, carbon, mineral and polymeric fibers.

In embodiments where blowing agent(s) and said gas generating substance(s) are utilized, they are in solid form including at least one of pellets and granules. In embodiments where gas generating substance(s) are utilized in pellet form they include a connection means for networking each pellet to one another for rapid activation. In yet other embodiments, the thermally-activated chemicals are placed throughout the support structure as a series of discrete particles and/or pellets. In still yet other embodiments, thermally-activated chemicals are in the form of a continuous paste or slurry throughout the support structure.

In other embodiments, blowing agent(s) further comprise water that is physically or chemically bound to the thermally-activated substances in a thermally reversible manner for absorbing heat and interfering with the chemical reactions that constitute burning upon release. In further embodiments, the blowing agent(s) is combined with the flame retardant polymer(s) before being activated by temperature above a pre-determined limit. When blowing agent(s), gas generating substance(s), flame retardant(s) and fuel absorbent(s) are utilized and formulated for activation separately when subjected to temperatures above a pre-determined limit. The activation thereafter causes synergistic foaming, popping, and disintegration reactions for transforming the chemical substances in the apparatus for having a lower density.

In embodiment, when the gas generating substance(s) is utilized, it is studded between or coupled to the support structure for rapid inflation of the apparatus. In other embodiments when blowing agent(s) and gas generating substance(s) are utilized, they are combined and formulated for activation when subjected to temperatures above a pre-determined limit that thereafter releases a gaseous substance(s) expanding to an effective volume, which acts as an effective insulator against heat. In other embodiments, the blowing agent(s), gas generating substance(s), flame retardant(s) and fuel absorbent(s) and any combination thereof are specifically formulated and combined before being activated when subjected to temperatures above a pre-determined limit. The activation causes synergistic foaming, popping, and disintegration reactions for transforming the chemical substances in the apparatus for having a lower density.

Further embodiments of the present invention include flame retardant edges that permit parallel coupling to a long axis of the apparatus for forming an escape tunnel and/or protective area against fire and hazardous heat. When flame retardants are utilized they include, but not limited to, at least one of potassium bicarbonate based compounds, aluminum trihydroxide, antimony oxide, antimony sulfide, antimony trichloride, sodium antimonite, phosphonitrilic chloride trimers and polymers, diammonium phosphate, zinc borates, hydrated zinc borates, hydrated aluminum oxide, ammonium bromide, molybdenum oxide, molybdenum sulfide, triphenyl phosphates hydrocarbon phosphates in which some or all hydrogen atoms are replaced with fluorine, chlorine, bromine, or iodine, perbrominated diphenyl ethers, triphenylphosphine oxide, thiourea, and epoxy, polyester, phenolic, silicone, or vinylic resins in which at least some hydrogen atoms have been replaced with fluorine, chlorine, bromine, or iodine. When inert gas generating substance(s) are utilized they include, but are not limited to, at least one of bis(5-aminotetrazolyl)tetrazine (BTATZ), 5-aminotetrazole (5-AT), strontium nitrate, magnesium carbonate, sodium bicarbonate, or potassium bicarbonate. When fuel absorbent(s) are utilized they include, but not limited to, at least one of a thermoplastic polymer, heat-resistant synthetic rubber in a porous or spongy form, and lipogels. And when blowing agent(s) are utilized they include, but not limited to, at least one of water, nitrogen, carbon dioxide, n-pentane, chlorofluorocarbons, hydrocarbons in which at least one hydrogen atom is replaced with bromine or iodine, hydrocarbon gas, sodium bicarbonate, toluene sulfonyl hydrazide, oxybis benzene sulfonyl hydrazide, azobisformamide, toluene sulfonyl semicarbazide, phenyl tetrazole, trihydrazinatriazine, azide compounds, and hydride compounds.

In embodiments, at least one support structure or core comprises at least one heat-resistant material(s), heat-resistant fiber(s), and heat-resistant film(s). In other embodiments, when heat-resistant film are utilized they include, but not limited to, at least one of chlorinated PVC and polyphenylene. The apparatus further comprises specifically structured rods in other embodiments. In embodiments, at least one core further includes a heat-resistant polymer having soft polyurethane in the form of an open-celled foam. In other embodiments, the heat-resistant layer(s) or core further includes a means for expansion having at least one of folds, expandable fiber(s), and strategic stitching. The support structure(s) in embodiment is further dimensioned and configured into the shape comprising of at least one of a porous or non-porous blanket, curtain, or mat for supporting at least one person.

The following are included in the coating embodiments. In embodiments, the apparatus further includes a heat-resistant layer constructed of woven heat-resistant fibers for accommodating the transportation of at least one of gaseous vapors, liquids via capillary action, application of pressure, and any combination thereof. The heat-resistant layer comprises of woven heat-resistant expandable fibers comprising at least one of glass, carbon, and polymeric fibers including Nomex®, Kevlar®, aromatic polyesters, semi-aromatic polyesters, and mineral fibers including asbestos. The substrate in other embodiments include at least one heat-resistant layer constructed of woven heat-resistant fibers comprising at least one of glass, carbon, and polymeric fibers including Nomex®, Kevlar®, aromatic polyesters, semi-aromatic polyesters, and mineral fibers including asbestos for forming a blanket or mat. The thermally-activated chemical(s) in embodiments include at least one heat-resistant layer and an adhering means for attaching the thermally-activated chemical(s) to the substrate. In other embodiments, the thermally-activated chemicals are in the form of a continuous paste or slurry on the substrate.

The apparatus employs a combination of thermally-activated blowing agent(s), inert gas(es) generating substance(s), fuel absorbent(s), and flame retardant(s). At least one of these are adhered to a robust support structure including a core sandwiched between and/or adhered to at least one heat-resistant layer. The heat-resistant layer includes a porous fabric or mat of heat-resistant materials (including coating the thermally-activated chemicals on a fabric of heat-resistant mat/blanket). A blowing agent is defined as a solid or liquid substance that is readily transformed by a physical phase transition or chemical reaction so as to generate very rapidly a much larger volume of gas or vapor at a predetermined temperature.

Under normal ambient temperatures, the apparatus exists in a compact state, in which a support structure(s) include enclosed spaces (strategically arranged for maximum protection against heat and fire) to house at least one thermally-activated chemical including, but not limited to, blowing agents, fuel absorbents, flame retardants, and inert gas generating substances. In one embodiment, the construction of the apparatus includes thermally-activated chemicals being strategically sandwiched between layers of a heat-resistant protective skin including a mat of fire-resistant fibers, that allows for the passage of liquids and vapors via capillary action or the application of pressure. When any part of the apparatus is exposed to temperatures of about 100° C. to 600° C. (in some embodiments the temperatures are about 40° C. to about 600° C. when using pentane or chlorofluorocarbons), nearby molecules of the gas generating substance begin to vaporize, generating an outward pressure on the mat. Embodiments of the apparatus are activated in its entirety and irreversibly when any one part is exposed to a predetermined temperature within the aforementioned range. One skilled in the art would appreciate that the pre-determined temperature range depends on the particular use of the apparatus.

Nearby enclosed spaces housing thermally-activated chemicals in the structural support are pulled apart by an outward force created by an increase in pressure within the apparatus due to volumetric expansion of pre-selected materials that change from a solid or liquid into a vapor (vapor phase). These forces result in an expansion in at least one dimension of the apparatus by stretching, uncoiling, unfolding, or inflating. Simultaneously, the combination of temperature and/or tension (that is, lowered pressure) created by expansion in nearby areas causes bubble formation in nearby blowing agent(s) in accordance with thermodynamic principles. Smith, J. M., H. C. Van Ness, and M. M. Abbott, “Introduction to Chemical Engineering Thermodynamics,” 6^{th} ed., McGraw-Hill, New York (2001). These forces are transferred to a heat-resistant layer or skin and surrounding support structure(s) to nearby enclosed spaces housing fuel absorbents, causing them to become significantly more porous either through activation events or by causing the expansion of previously folded and/or collapsed structures.

As inert gas generating substances continue to vaporize, they generate a local wave of heat and pressure that interacts with neighboring gas generating chemicals in a manner so as to propagate an outward moving wave of expansion across the apparatus at speeds ranging from about 0.01 to about 5,000 meters per second. The passage of the wave induces the same outward forces that act to expand the support structure, blowing agents, and fuel absorbents as the initial exposure to temperatures in the range of about 100° C. to 600° C. (in some embodiments the temperatures are about 40° C. to about 600° C. when using pentane). After the wave has spread through the entire apparatus, the support structure of the apparatus expands into a definite shape to support mechanical loads, protect an object or user, or to form an escape tunnel.

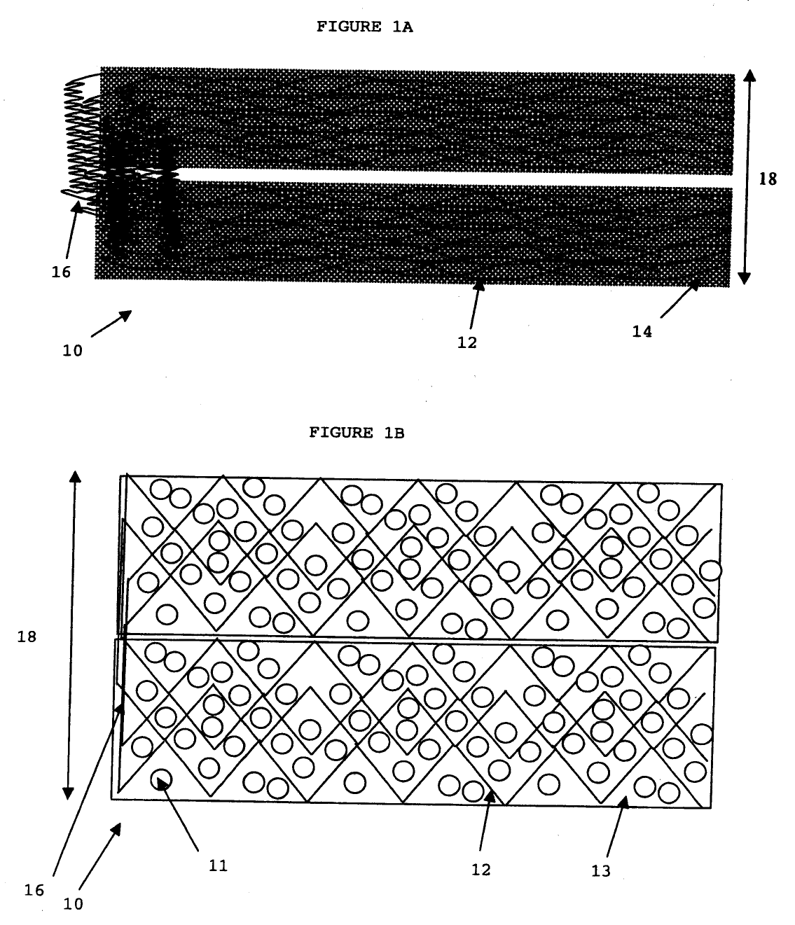

In one embodiment, this is achieved when expanded polymeric blowing agents, highly porous fuel absorbing chemicals, and void spaces are left by vaporized gas generating substances after being activated. As shown in FIGS. 1-3, the thickness of the apparatus at this point 18, 28, and 38 (t₂) is much greater than the initial thickness 18, 28, and 38 (t₁). The high temperatures associated with the initial heating event and the vaporization of the gas generators will cause thermally reactive “setting” substances to undergo chemical reactions that drastically increase the mechanical stiffness of thermally-activated chemicals housed in the support structural including blowing agents, and fuel absorbents, thereby imparting mechanical and thermal stability to the expanded apparatus.

In embodiments of the present invention, the blowing agents and inert gas generator substances are in solid form, and on exposure to a pre-determined temperature (adjustable according to the chemical composition of the substance employed), release significant quantities of relatively inert gases including nitrogen, water vapor, carbon dioxide, and gases that inhibit the chemical reactions associated with burning including halocarbon gases (including any gas derived from the elements carbon, hydrogen, fluorine, chlorine, bromine, and iodine), sulfur dioxide, and carbon monoxide. Blowing agents and inert gas generator substances in other embodiment are at least in gel and oil form. The pellet or granule forms act to promote rapid expansion and for increased volume of the apparatus. The physical forms of the apparatus include granules or pellets constructed to form a porous fill within an enclosed space, a rolled or folded curtain or blanket, a mat that supports the weight of multiple persons walking across it, or a long mat with edges that is joined parallel to the long axis so as to form an escape tunnel.

In other embodiments, the fuel absorbent(s) are the same materials into which the blowing agent(s) is incorporated. Yet still in other embodiments, the blowing agents and the fuel absorbents are separate domains of porous high-temperature, flame-retardant polymers. Embodiments of the present invention include the support structure being a frame or in the form of a porous substrate. In the aforementioned examples the polymeric fibers are substances including Nomex® or Kevlar® with outstanding heat resistance, or else of similar materials with equal or superior heat and flame resistance properties. The DuPont® product is a fiber with an extraordinary combination of high-performance heat- and flame-resistant properties, as well as superior textile characteristics and sold under the trademark Nomex®. Nomex® is commercially available in both fiber and sheet forms. The DuPont® product fiber consists of long molecular chains produced from poly-paraphenylene terephthalamide sold under the trademark Kevlar®. The apparatus is constructed to accommodate a pre-determined volume of gas-filled, solid-filled, and/or liquid-filled (including gel and oil forms) spaces that either is removed by the application of compressive forces during fabrication and/or by providing for slack in the confining surfaces of the apparatus. An example of an embodiment of the apparatus is capable of being in the form of a rolled mat.

The apparatus is constructed of lightweight, compact materials for easy transportability. The present invention is pre-positioned near or around pieces of equipment for which protection from fire is desired, or it is placed in an area easily accessed by persons engaged in firefighting activities or potentially threatened by fire. At temperatures typical of shipboard or aircraft working environments (up to about 85° C.) or storage environment (up to about 120° C.), the apparatus functions as an insulator and fuel absorbent. Upon experiencing temperatures above a predetermined limit; however, a planned release of gaseous substances with a significant volume takes place, by activation of a blowing agent (such as water of hydration) and/or by deflagration of the gas generator substance. The placement of the components to be activated is either as a series of discrete particles or pellets distributed throughout the body of the apparatus, or as a continuous paste or slurry of materials distributed throughout the body of the apparatus (for example, coated onto or into a woven mat or blanket).

Each thermally-activated chemical is specifically formulated and strategically placed within or on the support structure depending on its desired utility, so that upon activation, the thermally-activated chemicals would cause a significant expansion of the apparatus itself through a foaming, “popping,” or disintegrating action, with the actions being formulated in most cases to initiate the activation of nearby materials. In embodiments, gas generating substances would be activating nearby gas generating substances, blowing agents, and/or fuel absorbents, or blowing agents would be activating nearby gas generating substances, blowing agents, and/or fuel absorbents. In most cases the thermally-activated chemicals causing a “popping” action are encapsulated either because they exist in the form of a solid mass or because they are composed of a liquid surrounded by a solid coating. Encapsulation in most cases aids in increasing internal pressure (up to 10 atmospheres) to fully expand the apparatus. Since the expansion of localized portions of the apparatus initiates expansion of neighboring portions as described earlier, the expansion would propagate throughout the apparatus, transforming it into a substance of significantly lower density. In addition, upon exposure to temperatures in the range of about 100° C. to 600° C. (in some embodiments the temperatures are about 40° C. to 600° C. when using pentane or chlorofluorocarbons), thermal “setting” chemical reactions in the apparatus in constructed and formulated to produce a substantial increase in rigidity in order to render the expansion relatively irreversible and to provide support for mechanical loads.

Since the expanded apparatus is of low density, it would necessarily be highly porous and contain many gas-filled regions. The support structure of the expanded apparatus would thus provide greatly improved thermal insulating and fuel absorbing properties. The presence of inert gases and flame retardants act to disrupt chemical reactions sustaining a fire (the chemical composition of the apparatus would also be resistant to the reactions needed to sustain fire), the fuel absorbing properties act to diminish contact between fuel and oxygen, and the insulating properties act to delay and diminish increases in temperature. Thus, the apparatus simultaneously acts to resist class B fires (those involving flammable liquids) in all of the commonly available means. Furthermore, the mechanical properties of the apparatus allows it to define a region that for a short time presents a reduced hazard for persons in the vicinity, providing critically needed time to escape. In embodiments, the apparatus provides these functions with no human intervention or sources of electrical power. In other embodiments, the apparatus is controlled by attached or remote thermal detectors.

Some of the many unique qualities about the apparatus is that it is self-activated, operated in an unpowered autonomous manner, and performs multiple fire suppression functions simultaneously while being compact, lightweight, and highly mobile. Self-activation is achieved by combining gas generator substance and blowing agent technologies in a manner not presently practiced in state-of-the-art apparatuses, and not trivial or obvious to those practiced in the art of preparing fire suppression apparatuses. The multi-functionality of the apparatus also is the result of the ability to carefully control the chemical composition of heat-resistant polymeric materials to release gases and interact with gas generators.

Embodiments of the present invention will not melt and will undergo chemical reactions associated with burning only slowly, thus providing substantial benefits compared to current protective systems. The invention will also provide superior flame resistance and insulation at equivalent size (before expansion) and weight compared to fire blankets presently in use. Furthermore, the present invention will substantially increase the ability to safely and rapidly protect users and equipment from injury or damage as a consequence of exposure to severe thermal events (e.g. fire, thermobaric blast, rocket engine blast, etc. . . . ) and will provide additional mobility and short-term protection for firefighting personnel.

Protection of personnel and equipment from intense heat blasts is critical to safety and to ensure the capability of the warfighter to carry out and complete their respective tasks during military operations. It is necessary that the heat protection gear occupy a minimum amount of space and weight, but yet provide a maximum amount of heat insulation protection and resistance to very high temperatures since space is scare aboard ships and aircraft. Embodiments of the present invention creates a reactive (or smart or thermally activated) synthetic mat or blanket that when unactivated occupies a minimum amount of space; however, upon activation is assumes a pre-constructed shape with outstanding heat-resistance and the ability to protect a desired object and/or user.

### Prophetic Examples

The following prophetic examples are for illustration purposes only and not to be used to limit any of the embodiments.

1. In one embodiment of the invention, the apparatus includes a thermally-activated blanket or mat coated with thermally-activated chemicals. (Shown in FIGS. 1A&B) The fibers 12 of Nomex® with diameters of tens to hundreds of microns are woven into a rectangular fabric sheet approximately 100 cm×200 cm with sufficient slack left in the weave to accommodate stretching of a few percent. Two or more of these sheets would be knotted together around the edges with additional Nomex® or Kevlar® fibers 12 to form a protective blanket 10 approximately 1 mm thick. The sheet is impregnated with a dispersion of a blowing agent 14 including oxybis benzene sulfonyl hydrazide (OBSH) in molten phenol formaldehyde liquid mixture at a temperature of about 125° C. At about 125° C., the OBSH remains solid while the phenol-formaldehyde mixture is a low viscosity liquid. During the impregnation process, a curing reaction between the phenol and formaldehyde components takes place to a limited extent, increasing the viscosity of the liquid sufficiently to create a flexible gelatinous substance with a low vapor pressure among the fibers 12 upon cooling.

The resulting impregnated blanket 10 is stable at room temperatures for long periods; however, upon heating to temperatures of about 160° C. or above, the gel reverts to a fluid-like state (constructed to take place at temperatures slightly below 160° C.), including chemical decomposition of the OBSH blowing agent 14. The decomposition of the blowing agent 14 produces large quantities of nitrogen gas, which rapidly accumulates in the form of bubbles within the fluid. These bubbles cause the fluid to expand, pushing apart the woven fibers, and resulting in a stretching of the fabric 16, thereby expanding the apparatus into a pillow-like form. After a few tens of seconds at temperatures in excess of about 160° C., the curing reaction of the phenolic resin (or polymer) proceeds to completion, generating water molecules that are trapped among the bubbles, further expanding them, and transforming the resin into a rigid, heat-resistant material. At the completion of the process, the impregnated blanket 10 has been transformed into a pillow-like object with lateral dimensions within a few percent of the original dimensions of the fabric sheets but with a thickness of 15 to 30 mm (based on a typical closed-cell foam density of 0.03-0.06 g/cc for the interior). The resultant apparatus 10 would have an insulating R-value of 4-9 based on reported values of comparable (sprayed polyurethane) foam products, which equals that of 1″ to 2″ of mineral fiber wall insulation.

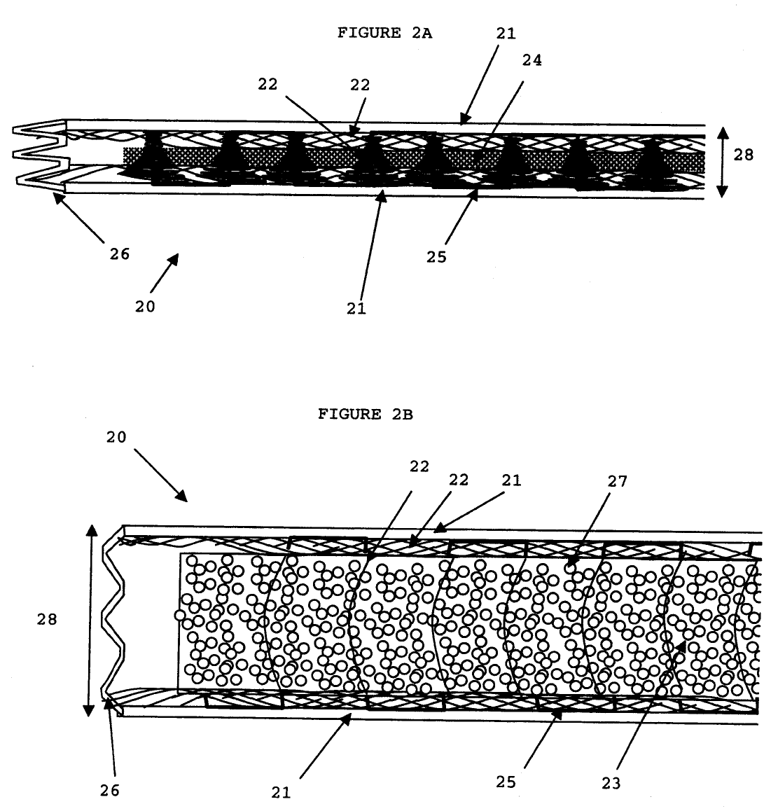

2. In another embodiment of the present invention, the apparatus 20 includes a thermally-activated blanket or mat with at least one heat resistant layer(s) and a core having thermally-activated chemicals. (Shown in FIGS. 2A&B) A 25-50 micron thick film 21 of Parmax® poly phenylene (or a similar polyphenylene film) coats a backing of Nomex® or Kevlar® fabric 22 forming an outer layer on the front, back, and sides of a mat 20 approximately 5 mm thick and of lateral dimensions ranging from a few millimeters to hundreds of meters. The sides of the mat 20 include extra folds 26 so as to accommodate a thickness of 75-150 mm upon expansion. At intervals of a few centimeters, the front side and back side of the mat 20 are stitched together with taut (expandable) fibers 25 constructed of Nylon-12. Running parallel to the Nylon-12 fibers 25 are lengths of Kevlar® or Nomex® fibers 22 with the same stitching pattern, but comprising 75-150 mm of fiber between the front and back surface, so that a large slack exists in these fibers. Thus, at each location where the front and back are joined, there are two parallel paths to accommodate tension, one is to be taut at a separation between front and back of 5 mm, and the other is to be taut at a separation between front and back of 75 mm. The pattern is envisioned as a shape resembling a highly distorted capital letter “D”, with the Nylon fiber comprising the straight portion and the Kevlar® or Nomex® fibers comprising the curved portion. The slack fibers in this embodiment are looped around the taut ones for lateral confinement.) The mat 20 is filled with a suspension of powdered chemical blowing agent 24 including azobisformamide (ABFA) in a gummy matrix of oligomeric polyphenylene having end groups including the maleimide chemical functionality. Upon heating to temperatures of about 150° C., the gummy matrix becomes a low viscosity fluid, allowing it to be introduced into the interior of the mat by gravity feeding from one side (prior to a final stitching together along one fold, for example). Upon cooling, the filling reverts to its gummy state, providing mechanical firmness and ease of handling. The stitching of the Nylon fibers 25 provides dimensional stability and compactibility 28.

Upon heating above the melting point of Nylon-12 (180° C.), the Nylon fibers 25 completely lose their ability to maintain tension, and therefore break, freeing the dimensional constraint on the mat thickness 28. At slightly higher temperatures, about 210° C., the ABFA chemically decomposes, generating a large volume of nitrogen gas, which produces large bubbles in the now liquefied phenylene oligomer filling, expanding the filling to about 15 to about 30 times its original volume. The expansion causes a straightening of the excess (accordion-like) folds 26, and a tensioning of the previously slack Kevlar® or Nomex® fibers 21. At a thickness of about 75 to about 150 mm, the expansion is halted by tension in the Kevlar® or Nomex® fibers 21 and the outer layer of the mat 20. After times of about 10 to about 100 seconds at a temperature in excess of about 210° C., the maleimide chemical groups becomes joined to one another in an irreversibly bound chemical network, transforming the liquid phenylene oligomer into a rigid, heat-resistant polymeric network. This expanded mat 20 has a predicted bulk density of about 0.04 to about 0.08 g/cc, and an R value of 4 to 8 per 25 mm, or 12-50, depending on the actual thickness. The combination of R-value and thermal stability of the materials ensures long-lasting thermal protection.

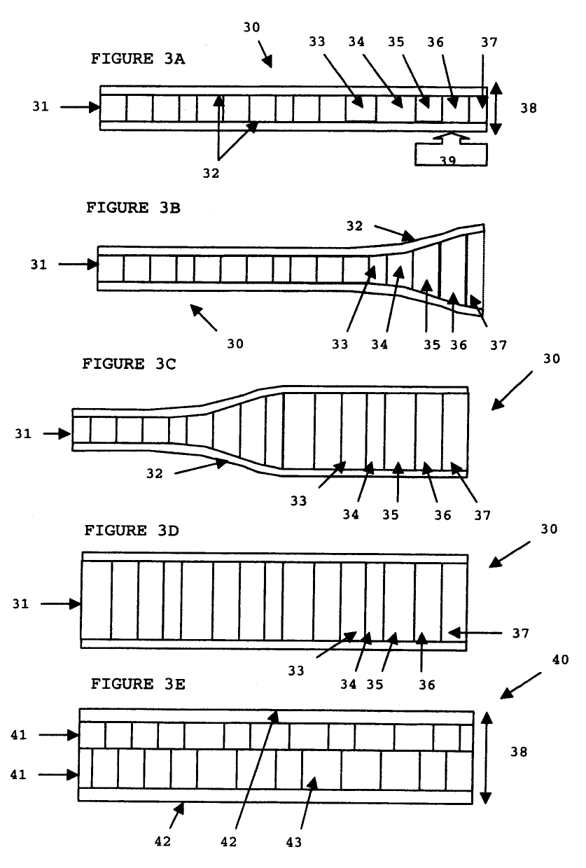

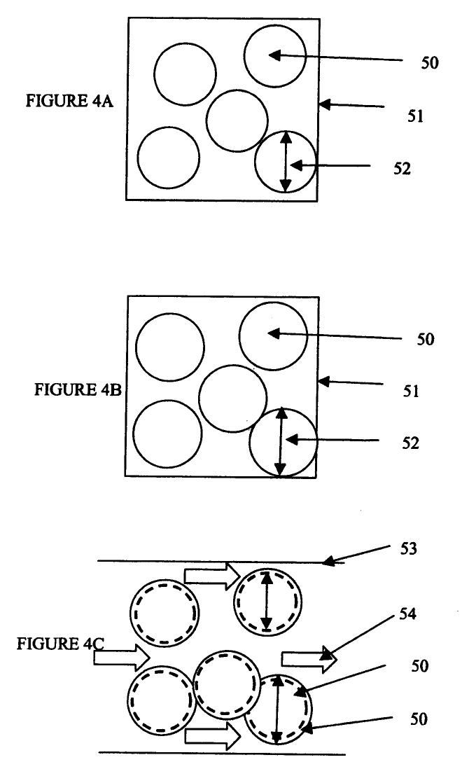

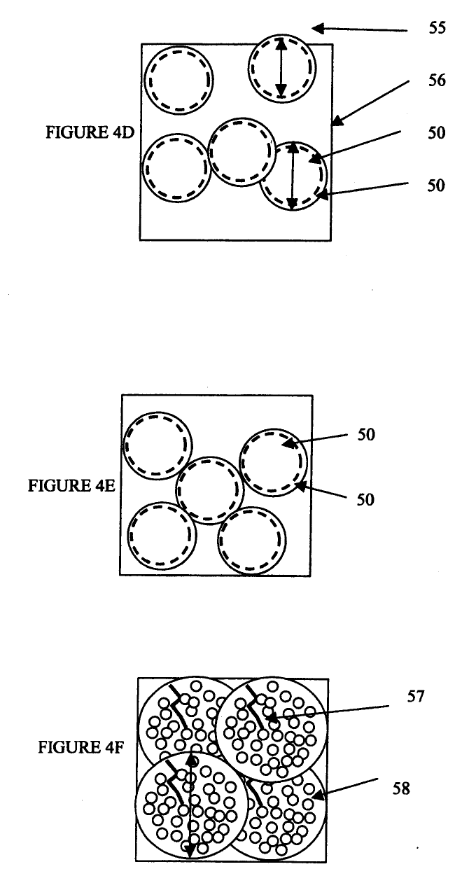

3. In another embodiment of the invention, the apparatus 40 includes a thermally-activated mat with heat resistant layers 42 and a plurality of core layers 41 including thermally-activated chemicals 43. (Shown in FIG. 3E) Individual assemblies identical to the one just described are stitched together in series with absorbent assemblies. Each absorbent assembly includes a heat-resistant polymer having soft polyurethane in the form of an open-celled foam. On the front and back side of the foam are stitched fabrics of Nomex® or Kevlar® fibers. Woven between the front and back side at regular intervals (5 cm, for example) is an arrangement of two fibers in parallel. One fiber is constructed of Nylon 12 and has a length of 5 mm of fiber between front and back sides, so that the fiber is under tension at a foam thickness of 5 mm. The other fiber is composed of Nomex® or Kevlar® and has a length of about 75 to about 150 mm between the front and back sides, thus it exhibits a large amount of slack. Under no restraining forces, the foam would have a thickness of about 75 to about 150 mm, matched to the length of the Nomex® or Kevlar® fibers running from the front to the back sides. However, upon stitching together the foam with the Nylon fibers, the foam is compressed to a thickness of about 5 mm, constructed to match the thickness of the other sections of the mat.

Upon heating to a temperature of about 180° C., the Nylon fibers melt and should no longer support the tension caused by constraining the foam, thus the foam rebounds to near its original thickness of about 75 to about 150 mm. The foam thus acquires the capacity to absorb liquids by a factor of about 15 to about 30 upon exposure to temperatures in excess of about 180° C. By stitching together segments of pre-compressed foam and segments of expandable polymer with a chemical blowing agent, the expansion forces unleashed upon melting of the Nylon fibers are transferred in part to the expandable polymer, assisting in its inflation.

4. In still another embodiment of the invention, the apparatus includes a thermally-activated coating on or in a wall or object. FIGS. 4A-F shows an embodiment of the present invention as it is formulated specific sized 52 granules 50, hydrated in container 51 suitable for immersion in water, container 53 for flash exposed to stream of hot, dry gas 54, use of hydraulic fluid 55 and container 56 for compaction, and activation of the particles 57 with hydrated interior and strong exterior walls 58. A Nomex® or Kevlar® woven fabric is mechanically pressed into a 5 mm thick slab of molten phenol-formaldehyde resin at a temperature of about 125° C. Dispersed into the resin at a loading of about 3 to about 7 percent by weight is a fine powder of the chemical blowing agent oxybis benzene sulfonyl hydrazide (OBSH). The pressing is performed in this embodiment, for instance, by suspending the fabric over the edges of a heated open mold, then applying light pressure to the upper part of the mold, and finally, allowing the mold to cool under pressure. During molding the liquid resin would penetrate the fibers and become adhesively bonded to the surface of a desired wall or object. Thus, an article having a large slab (for example, 100 cm×100 cm×5 mm) of phenol-formaldehyde resin with Kevlar® and/or Nomex® backing is produced upon demolding. The backing would be adhered to any horizontal or vertical surface using a layer of epoxy resin (including hydantoin epoxy prepolymer mixed with 15 parts per hundred polyamidoamine cured at about 65° C. for 1-2 hrs).

The coating is stable at room temperatures for long periods; however, upon heating to temperatures of about 160° C. or above, the phenol-formaldehyde resin is transformed from a gel to a fluid-like state (constructed to take place at temperatures slightly below 160° C.), followed by chemical decomposition of the OBSH blowing agent. The decomposition of the blowing agent produces large quantities of nitrogen gas, which rapidly accumulates in the form of bubbles within the fluid. After a few tens of seconds at temperatures in excess of about 160° C., the curing reaction of the phenolic resin proceeds to completion, generating water molecules that are trapped among the bubbles, further expanding them, and transforming the resin into a rigid, heat-resistant material. At the completion of the process, the coating has expanded to a thickness of about 75 to about 150 mm (based on a typical closed-cell foam density of about 0.03 to about 0.06 g/cc for the interior). The resultant apparatus would have an insulating R-value of 12-50.

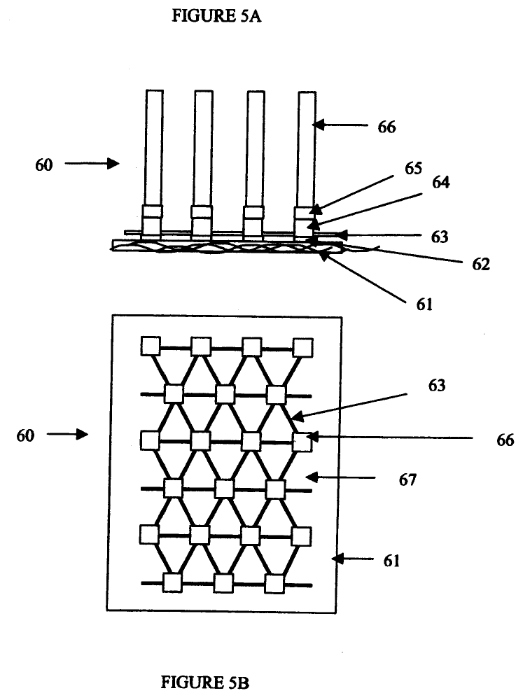

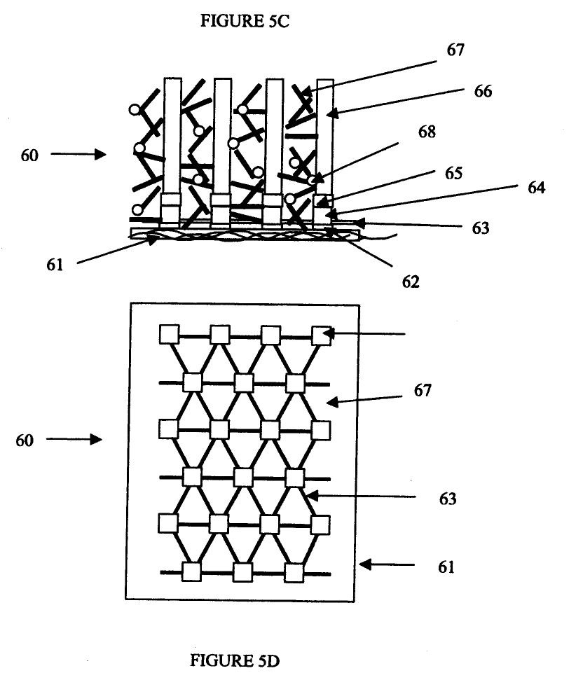

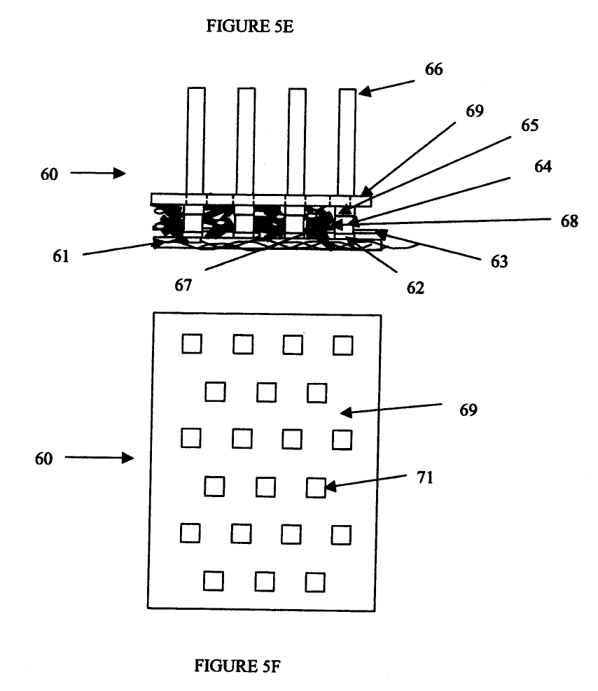

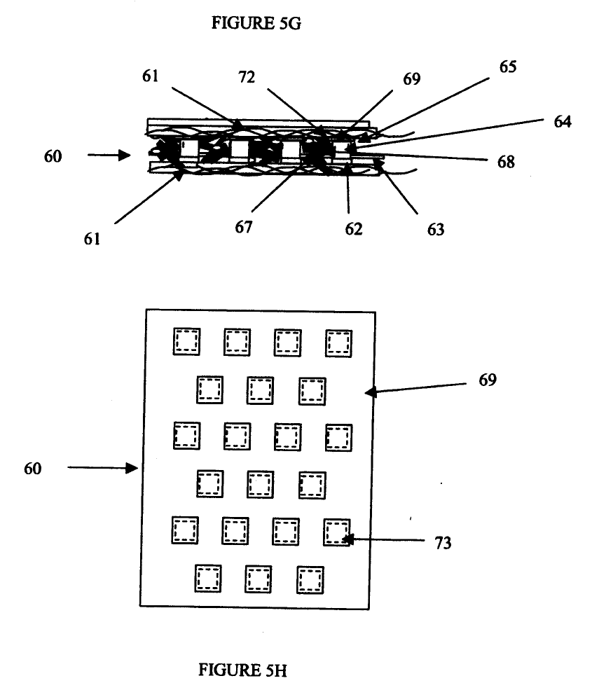

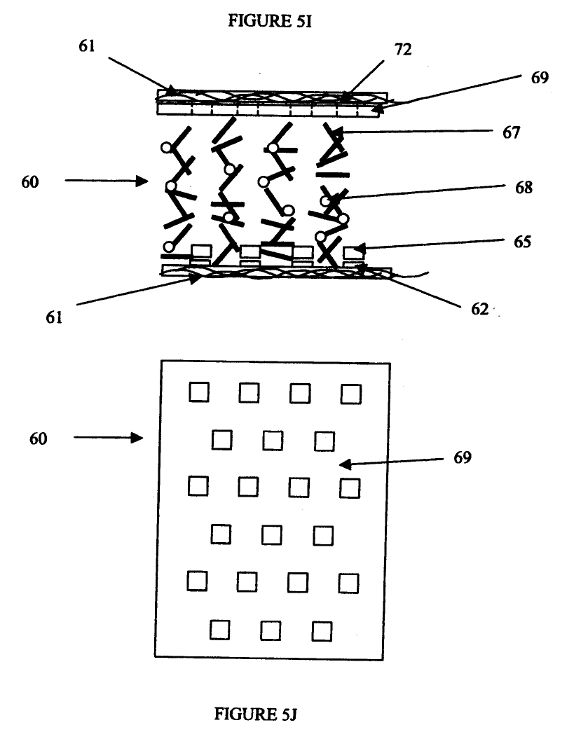

5. In yet another embodiment of the invention, the apparatus includes the thermally-activating chemicals including pellets, granules and a slurry or any combination thereof. (Illustrated in FIGS. 4A-F) Granules or pellets about 5 mm in diameter or length and composed of sulfonated poly-para-phenylene oligomer with maleimide end groups are allowed to soak in water at temperatures of about 90 to about 100° C. for 12-48 hrs, thus absorbing from about 10% to about 300% of their original weight in water depending on the degree of sulfonation. The granules or pellets are exposed to a stream of flowing dry air at temperatures up to about 80° C. for a length of time sufficient to remove most water from the outermost 100 microns or so of material (typically a few seconds or tens of seconds). Subsequently, the granules or pellets are immersed in a silicone oil having a viscosity less than 1000 cP and crushed at pressures up to 15,000 psi in order to collapse the outer layer. The result would be a granule or pellet with a hydrated interior and a dense outer skin. At room temperature the granules or pellets are a stable and easily handled solid that is poured or blown into cavities or any desired shape and any desired size larger than a few centimeters. Room temperature is defined as temperatures ranging from about −55° C. to about 90° C.? Upon heating to about 120° C., the granules are transformed into a fluid with a viscosity exceeding 100,000 cP. With additional heating, the pellets should begin to dehydrate; however, owing to their viscous nature and the presence of the dense outer skin, the pellets initially experience a rise in internal pressure rather than an expansion. At an internal pressure in excess of 50 psi the outer skin mechanically fails, leading to a rapid decrease in internal pressure coupled with a rapid volumetric expansion, in a manner analogous to the “popping” of a popcorn grain. After the expansion is complete, the granules are soft and foamy, with an unconstrained diameter of about 10 to about 15 mm. In this state, the granules should partially consolidate with neighboring granules to form a continuous structure. At higher temperatures, from about 200 to about 300° C., the maleimide end groups undergo a curing reaction, causing the foam to stiffen into a solid material and thus preventing the further merging or collapse of interior bubbles. The resultant foam is highly resistant to heat and flame, and possesses an R value from about 5 to about 10 per inch.
6. Another embodiment of the invention includes a thermally-activated mat having a wave activation of operation. The wave action is shown in FIGS. 3A-D, and embodiments including the rod or shaft examples are shown in FIGS. 5A-J. In FIGS. 3A-D, the embodiments illustrates the wave activation of operation. FIG. 3A shows the apparatus in a compact state 38 having a structural support means 33, a condensed, unhardened polymer with blowing agent 34, dense polymer absorbent 35, condensed gas generating substance 36, another thermally-activated chemical 37, two heat-resistance outer layers 32 and application of heat 39. FIG. 3B shows the initial expansion in response to high temperatures where a wave activation starts to occur. The unstable gas generator 36 begins to vaporize, the support structure expands 33, the blowing agent 34 actively begins to foam, absorbent 35 generating pores begin to form, and excess gas from newly vaporized gas generator 36 form. FIGS. 3C and 3D shows the propagation of expansion where the expanded support structures 33 are fully expanding the polymer foam 34 has hardened, the expanded absorbent 35 is highly porous, and voids are left by vaporized gas generators 36.

FIGS. 5A-J show the making of an embodiment of the apparatus 60. The mat 60 in these embodiments include an outer layer of Nomex® and/or Kevlar® fibers 61 forming the front and back side, and are stitched into folded films of chlorinated PVC 69 (in which 75 to 150 mm is folded like an accordion to fit into a 5 mm thickness) comprising the sides. Pellets 64 (about 5 mm in diameter and 3 mm thick) including the gas generator bis(5-amintetrazolyl)tetrazine (BTATZ) are adhered 72 on a 5 mm×5 mm face (via cured hydantoin epoxy 62 with 15 parts per hundred polyamidoamine cured for about 2 hrs at about 65° C.) to the interior side of one of the fabrics prior to stitching together the mat. The BTATZ pellets 64 are strategically arranged in a grid spaced about 2.5 cm apart, and are connected to one another by loosely looping a cord 63 of BTATZ between adjacent pellets 64. The concentration of BTATZ is controlled so as to allow for safe storage, handling, and operation. A specially constructed rod 66 is glued onto each of the pellets 64 at the side opposite to the previously bonded side. The specially constructed rods 66 are comprised of a polypropylene shaft 68 mm long by 5 mm wide and 5 mm thick onto which a tip (3 mm×5 mm×5 mm) of fully cured phenol-formaldehyde resin 65 would have been attached by spot welding at 120° C. The tip 65 is constructed in such a way that it would be broken off the rod easily but not by accident. Glass fibers 67 including those used for common building insulation are then laid down into the spaces between the rods 66 and pellets 64 to a depth of 75 mm, along with a small amount (1 to 3 parts per hundred glass by weight) of a phenol-formaldehyde adhesive binder that would be added by spraying). Uncured binder droplets 68 would be cured when the apparatus is exposed to temperatures in excess of 200° C. in order to provide mechanical stiffness after activation. A rigid board of chlorinated PVC 69 about 1 mm thick with holes 71 cut out to match the profile of the rods is slid over the tips of the rods and pressed down into the space between them, compacting the fiber mat to a thickness of 5 mm. At this point the board should surround the tips but not the shafts of the rods. The rod shafts are separated from the tips while the board is glued to the tips using a nylon-12 based hot melt adhesive 72. The top surface is covered with a Nomex® or Kevlar® fabric 61 and the sides are stitched in to complete construction of the mat.

At ambient temperature (defined here as −55° C. to 90° C.) the mat is a stable solid. However, at temperatures of about 180° C., the Nylon-12 adhesive between the rod tips embedded in the mat and the top board melt, allowing the top of the mat to detach from the BTATZ pellets and slip past the rod tips. At temperatures exceeding 200° C., the BTATZ pellets begin to vaporize, inflating the mat with nitrogen gas and allowing the previously compacted fibers to expand, until the mat reaches a thickness of about 75 mm. Once the phenol-formaldehyde board slips over the rod tips, the holes in which the rods were initially inserted remain open to prevent an excessive pressure from building inside the mat. At the same time, a covering of fabric remains over these holes, preventing the gas from escaping too rapidly. As a result, it is possible to construct the mat in a manner so as to achieve proper inflation pressure by controlling the size and weaving patterns of the outer mat. Within 10-300 seconds of exposure to elevated temperature (after expansion) the phenol-formaldehyde binder on the glass fibers cures, locking the structure in place. The expanded structure should have the same R-value as 3 inches (about 75 mm) of glass fiber insulation.

During a fire, apparatuses that perform life-saving and/or fire suppression functions in an unpowered autonomous manner allow for maximum reliability while reducing the danger to firefighters. Moreover, in an environment including onboard a ship or aircraft where space and weight are limited, an unpowered autonomous apparatus that performs multiple such functions simultaneously with a minimum of occupied space and weight would be extremely desirable. Major advantages of the present invention include, but are not limited to, fire blankets, fire protective clothing, firefighter's or emergency responder's clothing, thermal insulation, incorporated into blast walls, fuel tank liners (aircraft, vehicles, storage sites) and explosive safety foam, ordinance storage and container liners, bomb-resistant airline baggage containers, wire and cable insulation, and roof protection systems (system activates on a roof in response to being hit by a burning ember or to elevated temperatures caused by a building fire or nearby large natural fire).

Other applications for the present invention include, but not limited to, are document protection pouches, engine liners, general purpose fuel tank and ordinance covers, “rescue paths”—mats that are unrolled on a deck or floor to provide a flameproof path to walk or crawl to safety, “rescue tunnels” (festooned cylindrical mat that provides a fire-resistant corridor for escape purposes), liners for chemical reactors and chemical process equipment, liners for automobile and boat engines and/or fuel tanks, “blown in” insulation for buildings, vehicles, aircraft, ships, or other structures with accessible void spaces, chemical or fuel spill clean up kits, decontamination “squeegee” for persons or equipment in contact with flammable liquids, escape chutes for aircraft or tall structures, aerospace thermal protection systems, computer and telecom emergency protection systems, vault and safe fire protection systems, gas station clean-up and emergency use kits, cooking utensil insulation systems, food or biological sample refrigeration or thermal protection systems, and computer or electronics thermal protection systems.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

1. A firefighting and protection apparatus, comprising:
a substrate; and
a coating including at least one thermally-activated chemical comprising at least one of blowing agent(s), flame retardant(s), fuel absorbent(s), and inert gas generating substance(s) and any combination thereof, wherein said thermally-activated chemical(s) is activated when subjected to temperatures above a pre-determined limit, wherein said substrate includes a surface capable of being coated with at least one thermally-activated chemical, wherein said thermally-activated blowing agent(s) is formulated for activation when subjected to temperatures above a pre-determined limit, thereafter causes irreversibly expansion for increasing its volume, wherein said blowing agent(s) creates an effective volume which acts as an effective insulator against heat and having fuel absorbing properties, and wherein said blowing agent(s) having properties for disrupting chemical reactions which create fire and heat.

2.-8. (canceled)

9. The apparatus according to claim 1, wherein said thermally-activated chemical(s) include at least one heat-resistant layer and an adhering means for attaching said thermally-activated chemical(s) to said substrate.

10.-11. (canceled)

12. The apparatus according to claim 1, wherein said thermally-activated chemicals are in the form of a continuous paste or slurry on said substrate.

13.-14. (canceled)

15. The apparatus according to claim 1, wherein said blowing agent(s), said gas generating substance(s), said flame retardant(s) and said fuel absorbent(s) are formulated for activation separately when subjected to temperatures above a pre-determined limit, wherein said activation thereafter causes synergistic foaming, popping, and disintegration reactions for transforming said chemical substances in said apparatus for having a lower density.

16. The apparatus according to claim 1, wherein said blowing agent(s), said gas generating substance(s), said flame retardant(s) and said fuel absorbent(s) and any combination thereof are specifically formulated and combined before being activated when subjected to temperatures above a pre-determined limit, wherein said activation causes synergistic foaming, popping, and disintegration reactions for transforming said chemical substances in said apparatus for having a lower density.

17. The apparatus according to claim 1, wherein said apparatus further comprises flame retardant edges that permit parallel coupling to a long axis of said apparatus for forming an escape tunnel or protective area against fire and hazardous heat.

18-30. (canceled)
